(19) United States
(12) Patent Application Publication
(10) Pub. No.: US 2017/0268525 A1
(43) Pub. Date: Sep. 21, 2017

(54) IMPELLER WITH OUTER RING PRESSURE LOADING SLOTS

(71) Applicant: TI Group Automotive Systems, LLC, Auburn Hills, MI (US)

(72) Inventor: Edward Talaski, Caro, MI (US)

(21) Appl. No.: 15/454,468

(22) Filed: Mar. 9, 2017

Related U.S. Application Data
(60) Provisional application No. 62/308,474, filed on Mar. 15, 2016.

(51) Int. Cl. F04D 29/18; F02M 37/04; F02M 37/08; F04D 5/00; F04D 13/06

(52) U.S. Cl. CPC F04D 29/188; F04D 5/002; F04D 13/06; F02M 37/08; F02M 37/048

(57) ABSTRACT

An impeller for a fluid pump includes a central hub, an inner portion located adjacent to the central hub and an outer portion, the outer partially being radially outward from the inner portion. An array of vanes is located between the inner portion and the outer portion. At least one slot is formed within the outer portion. The at least one slot faces an angle of rotation of the impeller.

### CROSS REFERENCE TO RELATED APPLICATION

This application claims the benefit of U.S. Provisional Application No. 62/308,474 filed on Mar. 15, 2016, which is incorporated by reference in its entirety.

### BACKGROUND

1. Field of the Invention

The present disclosure generally relates to impellers and more particularly to impellers for turbine type fuel pumps.

2. Description of Related Art

Electric motor driven pumps may be used to pump various liquids. In some applications, like in automotive vehicles, electric motor driven pumps are used to pump fuel from a fuel tank to a combustion engine. In applications like this, turbine type fuel pumps having an impeller with a plurality of vanes may be used.

When using more viscous fuels, it has been observed that pumps show higher operating torque. This leads to lower speed and reduced fuel flow. This is because the rotor is being forced toward the inlet side of the impeller cavity.

### SUMMARY

A fluid pump may include an electric motor having an output shaft driven for rotation about an axis and a pump assembly coupled to the output shaft of the motor. The pump assembly has a first cap and a second cap with at least one pumping channel defined between the first cap and the second cap and an impeller received between the first cap and the second cap. The impeller is driven for rotation by the output shaft of the motor and includes a plurality of vanes in communication with the at least one pumping channel.

The impeller for the fluid pump may include a hub having an opening adapted to receive a shaft that drives the impeller for rotation. Also, the impeller may also include an inner portion and an outer portion. Both the inner and the outer portions are spaced radially away from the hub. The inner portion is located closer to the hub, while the outer portion is located further away from the hub, near to and forming a perimeter ring of the impeller.

Located between the inner portion and the outer portion are a circularly arranged array of vanes. The array of vanes is located radially outwardly of the inner portion but inwardly of the outer portion. Each vane in the array has a leading face and a trailing face spaced circumferentially behind the leading face relative to the intended direction of rotation of the impeller. The outer portion of the impeller includes an outer ring portion. The outer ring portion includes at least one slot that is generally facing radially outward from the hub of the impeller.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a sectional view of an exemplary fluid pump showing portions of an electric motor and pumping assembly of the fluid pump;

FIG. 2 is a sectional view of a pumping assembly of the fluid pump showing upper and lower caps and an impeller;

FIG. 3 is a top view of the upper cap;

FIG. 4 is a side view of the upper cap;

FIG. 5 is a sectional view of the upper cap;

FIG. 6 is a bottom view of the upper cap showing a lower surface of the upper cap;

FIG. 7 is a top view of the lower cap showing an upper surface of the lower cap;

FIG. 8 is a side view of the lower cap;

FIG. 9 is a sectional view of the lower cap;

FIG. 10 is a fragmentary sectional view of a portion of the lower cap showing vent passages formed therein;

FIG. 11 is a perspective view of the impeller; and

FIG. 12 is a more detailed view of a portion of the impeller.

### DETAILED DESCRIPTION

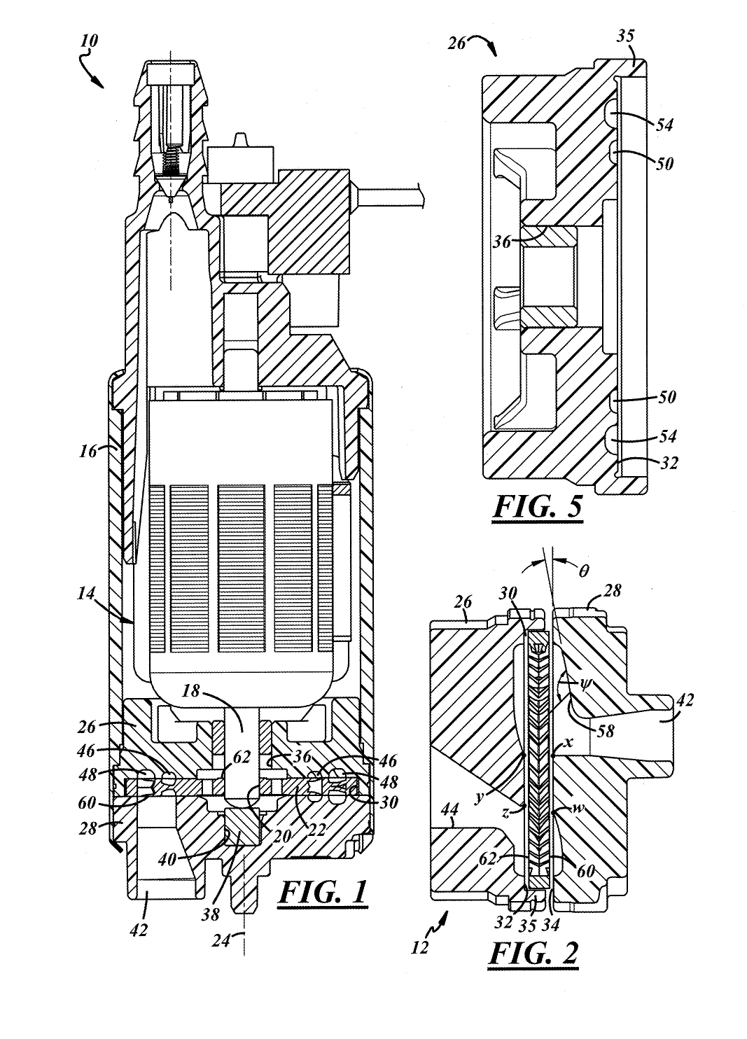

Referring now to FIG. 1, a liquid pump 10 that has a turbine type or impeller pump assembly 12, shown in FIG. 2, that may be driven for rotation by an electric motor 14 is shown. The pump 10 can be used to pump any suitable liquid including, and for purposes of the rest of this description, automotive liquids including, but not limited to, automotive fuels. In this example, the pump 10 may be utilized in an automotive fuel system to supply fuel under pressure to the vehicle's engine. The fuel may be of any suitable type, and the pump 10 may be adapted for use in a so-called “flex fuel vehicle” that may use standard gasoline as well as alternative fuels like ethanol-based E85 fuel.

The motor 14 and associated components may be of conventional construction and may be enclosed, at least in part, by an outer housing or sleeve 16. The pump assembly 12 may also be enclosed, at least in part, by the sleeve 16 with an output shaft 18 of the motor 14 received within a central opening 20 of an impeller 22 to rotatably drive the impeller 22 about an axis 24 of rotation.

As shown in FIGS. 1 and 2, the pump assembly 12 may include a first or lower cap 28 and a second or upper cap 26 held together and generally encircled by the sleeve 16. An impeller cavity 30 in which the impeller 22 is received, may be defined between a lower surface 32 of an upper cap 26 and an upper surface 34 of a lower cap 28. The lower surface 32 and upper surface 34 may be generally flat or planar and may extend perpendicularly to the axis 24 of rotation. The motor output shaft 18 may extend through a central passage 36 in the upper cap 26, be coupled to and project through the opening 20 in the impeller 22 with an end of the shaft 18 supported by a bearing 38 located in a blind bore 40 in the lower cap 28.

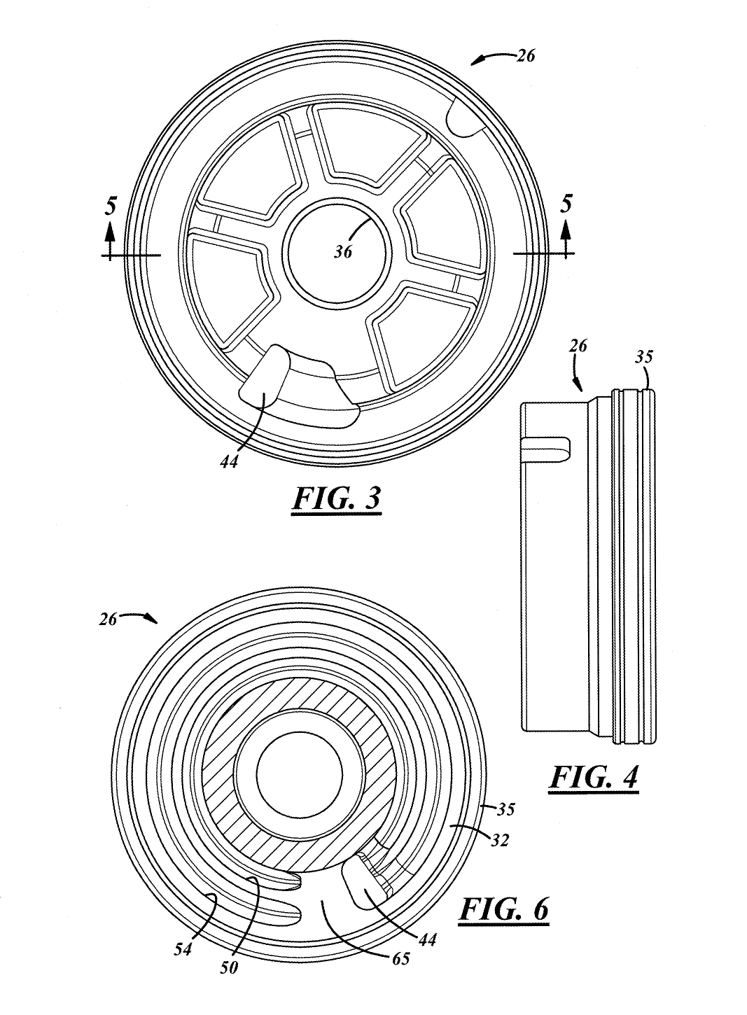

One or more fuel pumping channels 46, 48 (FIG. 1) are defined within the impeller cavity 30. The pumping channels 46, 48 may be defined by and between the impeller 22 and the upper and lower caps 26, 28. The pumping channels 46, 48 may communicate with and extend between an inlet passage 42 and an outlet passage 44, so that fuel enters the pumping channels 46, 48 from the inlet passage 42 and fuel is discharged from the pumping channels 46, 48 through the outlet passage 44. In the implementation shown, two pumping channels are provided, with an inner pumping channel 46 disposed radially inwardly or an outer pumping channel 48. The lower cap 28 (FIGS. 1, 2, 7-9) may define all or part of the inlet passage 42 through which fuel flows from a fluid reservoir or fuel tank (not shown) into the pumping channels 46, 48. The upper cap 26 (FIGS. 1-6) may define all or part of an outlet passage 44 through which pressurized fuel is discharged from the pumping channels 46, 48.

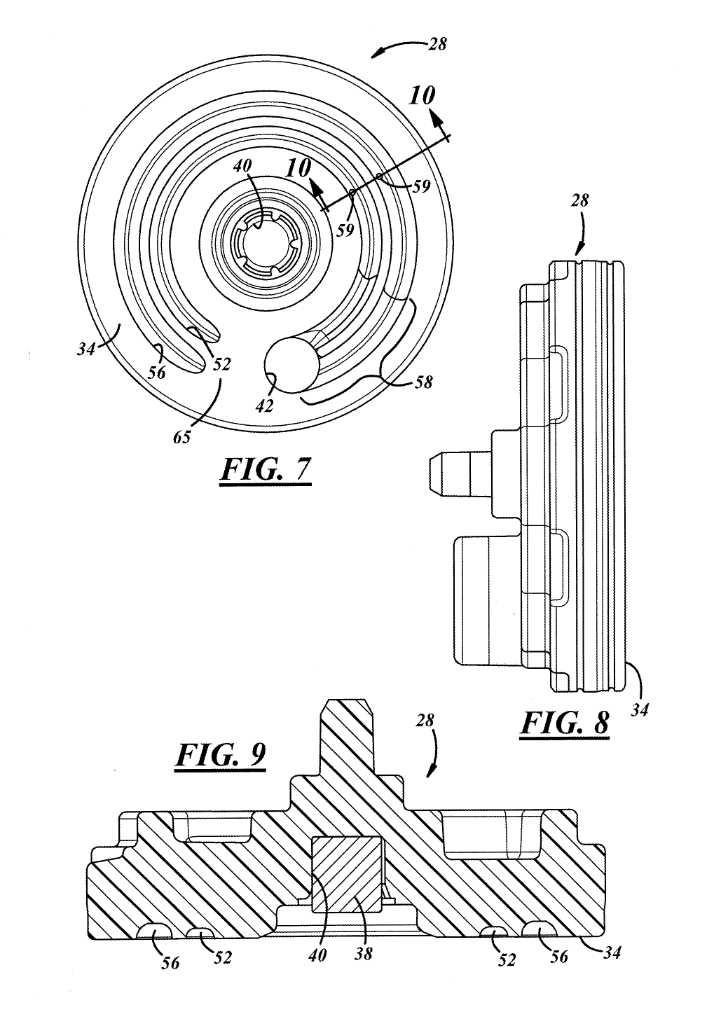

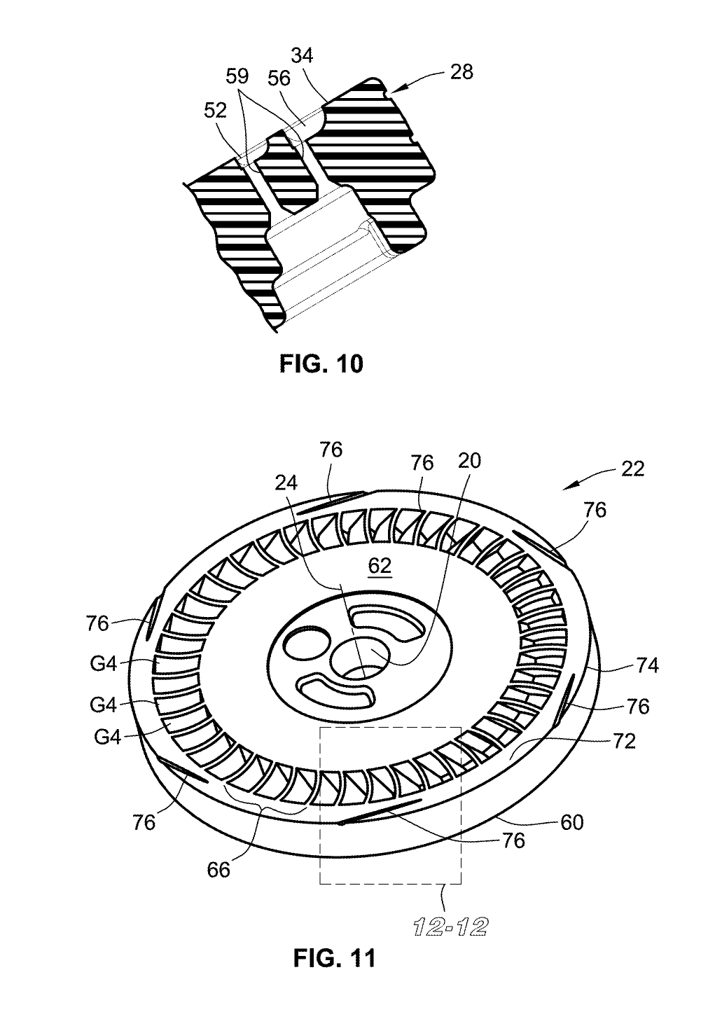

The inner pumping channel 46 may be defined in part by opposed grooves, with one groove 50 (FIGS. 5 and 6) formed in the lower surface 32 of the upper cap 26 and the other groove 52 (FIGS. 7 and 9) formed in the upper surface 34 of the lower cap 28. The outer pumping channel 48 may also be defined in part by opposed grooves, with one groove 54 (FIGS. 5 and 6) formed in the lower surface 32 of the upper cap 26 and the other groove 56 (FIGS. 7 and 9) formed in an upper surface 34 of the lower cap 28. The grooves 50-56 may all be symmetrically shaped and sized, or, they could be non-symmetrically shaped and/or sized. For example, the grooves 50, 52 defining part of the inner pumping channel 46 could generally be the same in the upper and lower caps 26, 28, but different from the grooves 54, 56 defining part of the outer pumping channel 46. As shown in FIG. 10, vent paths 59 may be provided for one or both pumping channels 46, 48 to permit vapor to escape or be expelled from the channels.

As shown in FIGS. 2 and 7, the inlet passage 42 may lead to an entrance portion 58 of the pumping channels 46, 48, with the entrance portion of outer pumping channel 48 shown. In the entrance portion 58, the depth of the pumping channel 48 may change from a greater depth adjacent to the inlet passage 42 to a lesser depth downstream thereof. The reduction in flow area downstream of the inlet passage 42 facilitates increasing the pressure and velocity of the fuel as it flows through this region of the pump assembly 12. In at least some implementations, the entrance portion may be disposed at an angle θ (FIG. 2) of between about 0° and 30°. In one presently preferred application, angle θ is between about 13° and 14°.

The outer pumping channel 48, as shown in FIGS. 5, 6, 7 and 9, may have a cross-sectional area that is larger than that of the inner pumping channel 46. The inner pumping channel 46 may operate at a lower tangential velocity and a higher pressure coefficient than the outer pumping channel 48 (due to the smaller radius and the shorter circumferential length of the inner pumping channel). In order to reduce leakage and/or backflow in the inner channel 46, as well as to maximize output flow, a smaller cross-sectional area may be used for the inner pumping channel 46 compared to the outer pumping channel 48.

The pumping channels 46, 48 may extend circumferentially or for an angular extent of less than 360°, and in certain applications, about 300-350° about the axis of rotation. This provides a circumferential portion of the upper and lower caps 26, 28 without any grooves. This circumferential portion without grooves may be called a stripper portion or partition 65 and is intended to isolate the lower pressure inlet end of the pumping channels 46, 48 from the higher pressure outlet end of the pumping channels. Additionally, there may generally be no, or only a limited amount, of cross fluid communication between the inner and outer pumping channels 46, 48. Limited cross fluid communication between the pumping channels 46, 48 may be desirable to provide a lubricant or a fluid bearing between the rotating impeller 22 and the stationary caps 26, 28.

As shown in FIG. 2, in at least one implementation, a radially inward edge of the inlet 42 at the face 34 of the lower body 28 (shown at point X) may be radially aligned with a radially inward edge of the inlet at the face 32 of the upper body 26 (shown at point Y). That is, a line connecting point X and point Y may be parallel to the axis of rotation. Further, the radially inward edge of the outlet 44 at the face 34 of the lower body 28 (shown at point W) may be circumferentially offset from the radially inward edge of the outlet 44 at the face 32 of the upper body 26 (shown at point Z) by between about 0° and 20°, with a presently preferred offset in one application being about 4°. Further, points X and Y may be circumferentially offset from point Z by about 10° to 25°, with a presently preferred offset in one application being about 23°. These angles may be measured between lines that are parallel to the axis of rotation and extend through the noted points.

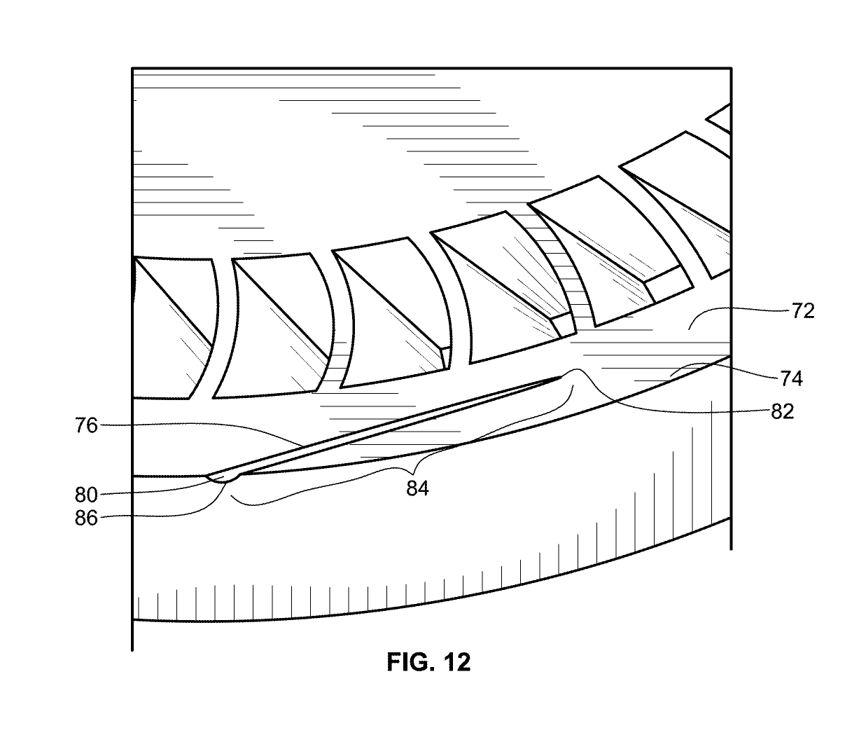

The pumping channels 46, 48 may also be defined in part by the impeller 22. As shown in FIGS. 1 and 11, impeller 22 may be a generally disc-shaped component having a generally planar upper face 62 received adjacent to the lower surface 32 of the upper cap 26, and a generally planar lower face 60 received adjacent to the upper surface 34 of the lower cap 28. As shown in FIG. 11, the impeller 22 may include a plurality of vanes 64 each radially spaced from the axis of rotation 24 and aligned within a pumping channel 46 or 48. As shown in FIG. 11, the impeller 22 only includes a single array 66 of vanes 64 that are rotated through a single pumping channel. In this case, the pumping channels 46 and 48 would be combined into a single channel. Conversely, the impeller 22 could also be made to include two arrays of vanes, which would utilize separate pumping channels 46 and 48. An example of an impeller with two arrays of vanes is shown and described in U.S. Patent Application Publication No. 2012/0201700, which is herein incorporated by reference in its entirety.

In one non limiting example, the impeller 22 may generally include an inner portion 70 and an outer portion 72. The inner portion 70 is located between a hub 68 and the array 64 of vanes 66. An outer portion 72 is located adjacent the array 64, opposite of the inner portion 70. As such, the outer portion 72 is located radially further away than the inner portion 70, with the array 66 of vanes 64 located between the two. Each vane in the array has a leading face and a trailing face spaced circumferentially behind the leading face relative to the intended direction of rotation of the impeller. The inner portion 70 of the impeller 22 may be provided radially inwardly of the array 66 of vanes, and a hole 20 of the hub 68 may be provided to receive the motor output shaft 18 such that the shaft and impeller co-rotate about axis 24.

The outer portion 72 of the impeller 22 includes an outer ring portion 74. The outer ring portion 74 includes at least one slot 76 that is generally radially outward from the hub 68 of the impeller 22. The At least one slot 76 is formed within the outer portion 72 and extends to the outer ring 74. The at least one slot 76 generally has a cross-section that decreases as it extends away from the outer ring 74 and proceeds more interiorly into the outer portion 72. The slot 76 generally faces the direction of rotation. In the implementation shown in FIG. 11, a total of six slots 76 are utilized. Of course, it should be understood, that any one of a number of slots may be utilized.

Referring to FIG. 12, an up close view of a portion of the impeller 22 is shown. As stated above, the slot 76 is formed within the outer portion 72 of the impeller 22. The slot 76 as an opening 80 that is connected to a channel 84. The channel 84 terminates at a distal end 82. The opening 80 may be a semicircular opening 86. Generally, the width of the channel 84 becomes narrower as the channel 84 extends from the opening 80 to the distal end 82.

As a person skilled in the art will readily appreciate, the above description is meant as an illustration of an implementation of the principles this invention. This description is not intended to limit the scope or application of this invention in that the invention is susceptible to modification, variation, and change, without departing from the spirit of this invention, as defined in the following claims.

I/We claim:

1. An impeller for a fluid pump, the impeller comprising:
a central hub;
an inner portion located adjacent to the central hub, the inner portion radially extends from the central hub;
an outer portion, the outer partially being radially outward from the inner portion, the outer portion having an outer ring defining a circumference of the impeller;
an array of vanes located between the inner portion and the outer portion; and
at least one slot being formed within the outer portion, the at least one slot facing an angle of rotation of the impeller.

2. The impeller of claim 1, wherein the slot further comprises a channel, the channel having an open end located at the outer ring and a distal portion extending from the open end and into the outer portion.

3. The impeller of claim 2, wherein the channel narrows from the open end to the distal end.

4. The impeller of claim 1, wherein the at least one slot comprises a plurality of slots.

5. The impeller of claim 4, wherein the plurality of slots are spaced apart an equal distance from each other along the outer ring.

6. The impeller of claim 5, wherein each of the plurality of slots further comprise a channel, the channel having an open end located at the outer ring and a distal portion extending from the open end and into the outer portion.

7. The impeller of claim 6, wherein the channel narrows from the open end to the distal end.

8. The impeller of claim 1, wherein the vanes configured to communicate with a fluid inlet and a fluid outlet.

9. The impeller of claim 8, wherein each vane in the array has a leading face and a trailing face spaced circumferentially behind the leading face relative to the intended direction of rotation of the impeller.

10. The impeller of claim 1, wherein the impeller includes a second array of vanes located between the inner portion and the outer portion.

11. A fluid pump comprising:
an electric motor having an output shaft driven for rotation about an axis;
a pump assembly coupled to the output shaft of the motor, the pump assembly having a first cap and a second cap, with at least one pumping channel defined between the first cap and the second cap;
an impeller disposed between the first cap and the second cap, the impeller further comprising:
a central hub;
an inner portion located adjacent to the central hub, the inner portion radially extends from the central hub;
an outer portion, the outer partially being radially outward from the inner portion, the outer portion having an outer ring defining a circumference of the impeller;
an array of vanes located between the inner portion and the outer portion, the vanes being in fluid communication with the at least one pumping channel; and
at least one slot being formed within the outer portion, the at least one slot facing an angle of rotation of the impeller

12. The fluid pump of claim 11, wherein the slot further comprises a channel, the channel having an open end located at the outer ring and a distal portion extending from the open end and into the outer portion.

13. The fluid pump of claim 12, wherein the channel narrows from the open end to the distal end.

14. The fluid pump of claim 11, wherein the at least one slot comprises a plurality of slots.

15. The fluid pump of claim 14, wherein the plurality of slots are spaced apart an equal distance from each other along the outer ring.

16. The fluid pump of claim 14, wherein each of the plurality of slots further comprise a channel, the channel having an open end located at the outer ring and a distal portion extending from the open end and into the outer portion.

17. The fluid pump of claim 16, wherein the channel narrows from the open end to the distal end.

18. The fluid pump of claim 11, wherein the vanes configured to communicate with a fluid inlet and a fluid outlet.

19. The impeller of claim 18, wherein each vane in the array has a leading face and a trailing face spaced circumferentially behind the leading face relative to the intended direction of rotation of the impeller.

20. The impeller of claim 11, wherein the impeller includes a second array of vanes located between the inner portion and the outer portion.
